(19) United States
(12) Patent Application Publication
(10) Pub. No.: US 2011/0258212 A1
(43) Pub. Date: Oct. 20, 2011

(54) AUTOMATIC QUERY SUGGESTION GENERATION USING SUB-QUERIES

(75) Inventors: JIANPING LU, Beijing (CN); DONGHUI ZHANG, Beijing (CN); HOWARD SHI KIN WAN, Boston, MA (US)

(73) Assignee: MICROSOFT CORPORATION, Redmond, WA (US)

(21) Appl. No.: 12/760,128

(22) Filed: Apr. 14, 2010

(51) Int. Cl. G06F 17/30

(52) U.S. Cl. 707/760; 707/765; 707/E17.074

(57) ABSTRACT

Query suggestions can be generated by identifying desirable sub-queries. Search engine data can be accumulated to determine usage characteristics for various queries. Potential sub-queries can be generated and ranked based on the usage data. After ranking potential sub-queries, the rankings can be used to select sub-queries when a search request is received. The selected sub-queries can be used directly as query suggestions, or the sub-queries can be used as input for another query suggestion engine.

### BACKGROUND

Keyword or query searching of large document collections, such as documents available on a network, is now a common activity. As search engines have become more readily available, the number of users of search technology has increased, and these users search an increasing range of topics. As a result, many searches are conducted by users in topic areas that the user is unfamiliar with. This can lead to difficulties for the user in formulating a search query.

In an effort to aid users of search technology, query suggestions are sometimes offered as part of the response to a search query. The query suggestions provide users with alternative queries that a user can select. This can help the user identify other search queries that may be better suited for finding information of interest.

### SUMMARY

In various embodiments, query suggestions can be generated by identifying desirable sub-queries. Search engine data can be accumulated to determine usage characteristics for various queries. Potential sub-queries can be generated and ranked based on the usage data. After ranking potential sub-queries, the rankings can be used to select sub-queries when a search request is received. The selected sub-queries can be used directly as query suggestions, or the sub-queries can be used as input for another query suggestion engine.

This Summary is provided to introduce a selection of concepts in a simplified form that are further described below in the Detailed Description. This Summary is not intended to identify key features or essential features of the claimed subject matter, nor is it intended to be used as an aid, in isolation, in determining the scope of the claimed subject matter.

### BRIEF DESCRIPTION OF THE DRAWINGS

The invention is described in detail below with reference to the attached drawing figures, wherein:

FIG. 1 is a block diagram of an exemplary computing environment suitable for use in implementing embodiments of the present invention.

FIG. 2 schematically shows a system suitable for performing an embodiment of the invention.

FIG. 3 depicts a flow chart of a method according to an embodiment of the invention.

FIG. 4 depicts a flow chart of a method according to an embodiment of the invention.

FIG. 5 depicts a flow chart of a method according to an embodiment of the invention.

FIGS. 6 and 7 depict results from application of an embodiment of the invention using Chinese written language query elements.

### DETAILED DESCRIPTION

### Overview

In various embodiments, systems and methods are provided for generating query suggestions. The generation of the query suggestions can be based on first identifying one or more sub-queries with a high ranking. The one or more high ranking sub-queries can be used as query suggestions, or the one or more sub-queries can be used as input for a conventional query suggestion methodology. In some embodiments, the systems and methods can be used for query suggestions based on longer queries, such as queries that contain from four to about sixty query elements. In other embodiments, the query suggestions can be generated automatically, using systems and methods that do not require human intervention. The systems and methods can also be applied to various languages, regardless of the nature of the query element used for a language. Thus, the systems and methods can be applied effectively to queries where the query elements are words (such as a query in English) as well as to queries where the query elements are characters (such as a query in Chinese, Japanese, or Korean).

Although providing query suggestions to a user is conventional, there are still many obstacles to providing high quality suggestions. One such obstacle can be providing query suggestions based on queries with a large number of query terms. An increasing number of search queries are queries that include four or more keywords or query elements. Part of the increase in the number of terms is the increase in use of “natural language” queries, where a query is a partial or even a complete sentence rather than a collection of keywords. Such long queries are easier to formulate for less experienced users. Longer queries can also be used to further specify a desired search target. When searching a large document collection, a longer query can be helpful for generating a more relevant ordering of the search results.

While longer queries can provide benefits for a searcher, conventional methods of providing suggested queries can be less effective for long queries. Many query suggestion methods are based on addition of popular terms or substitution of a correlated term. For a search query with only two or three query elements, each query element can be used as the basis for varying a query without generating an unduly large list of options to choose from. However, as a query increases in length, the number of variations can increase exponentially, leading to a large number of permutations that are evaluated in order to determine the query suggestions.

Another difficulty in providing query suggestions can be related to providing query suggestions across various languages. For example, a query suggestion algorithm could use the syntax of a natural language query to focus on the most relevant query elements. Unfortunately, this approach requires modifying the query suggestion algorithm for each different language used. Such a modification can be substantial, due to the widely differing syntax for a character-based written language such as Chinese. Additionally, even within a single language such as English, variations in syntax can require a different algorithm for each English speaking region.

A related problem is the difficulty faced by any search engine where human intervention or training is required for the query suggestions. Human training can include providing a dictionary of words that are treated in a special way, such as words that can be ignored when making a suggestion, or words that should be correlated. Human training can also include providing a set of training documents that are used to develop correlations. Regardless of the type of training, the need for human intervention will mean that updates to the query suggestion system will be infrequent and time consuming. This can cause the suggestions from a query suggestion system to be out of date.

In some embodiments, systems and methods are provided for providing query suggestions automatically, without relying on human training of a query suggestion system. The system and method can be independent of language syntax, so that the system and method can be used for various languages with little or no modification. Additionally, the system and method can be effective for making query suggestions based on queries having four to about sixty query terms. Additionally, in some embodiments the system and method can be used in conjunction with existing query suggestion technology.

### Queries and Sub-Queries

A query can include one or more query elements. A query element is a discrete portion of the query. For a query in English, a query term is typically a word. It is noted that a “word” here denotes a group of letters, numbers, and/or other symbols that could be used and understood by a searcher as a single query term. For example, a searcher looking for additional information about propane could enter “C3H8” as part of a query. In this situation, it is understood that “C3H8” constitutes a query term. Optionally, for a search engine that allows for search for a phrase, such as by placing a series of words in quotation marks or in brackets within a query, such a phrase could be considered a single query term. By contrast, in a query regarding chocolate cake, the letters “ch” would not be considered a query term, as this is not a full “word” within the query as submitted. In a character-based written language such as Chinese, Japanese, or Korean, a query element can be a character.

The query length for a query is defined as the number of query elements in the query. In some embodiments, query suggestions can be provided for all queries of any query length. Alternatively, query suggestions can be provided for queries having a query length of at least 4 query elements to about 60 query elements. The query length can be at least 4 query elements, or at least 5 query elements, or at least 6 query elements. The query length can be about 75 query elements or less, or about 60 query elements or less, or about 50 query elements or less, or about 40 query elements or less.

A sub-query is a query formed from one or more query elements of a parent query. One way to identify the possible sub-queries for a query is by forming n-grams. One way to form n-grams is to form all possible combinations of query elements that result in a shorter query while preserving the order of the query elements. In other words, query elements can be removed from the query from the beginning, middle, or end of the query without changing the order of the remaining query elements. Such n-grams can be referred to as position-dependent n-grams. For a four element query, possible sub-queries can correspond to the four 1-element n-grams, the six 2-element n-grams, and the four 3-element n-grams. Alternatively, position independent sub-queries can be formed where query elements are allowed to change position in the sub-query. For a query containing four query elements, there are four 1-element position-independent sub-queries, 12 2-element position-independent sub-queries, and 24 3-element position-independent sub-queries.

In still another embodiment, sub-queries can be formed using consecutive strings of query terms from the parent query. In such an embodiment, query terms can be dropped from the beginning or the end of a parent query, but a query term is not dropped if it is between other query terms that are retained in the sub-query. For a query containing four query elements, this type of embodiment can produce four 1-element sub-queries, three 2-element sub-queries, and two 3-element sub-queries.

In an optional embodiment, a query or sub-query can include obvious variations of any query element in a query. For example, some word processing programs now include a spelling check functionality, where words not in the spelling check dictionary can be automatically corrected if it is relatively clear what the intended word should be. In such an optional embodiment, spelling errors can be corrected prior to the process of forming sub-queries, such as by forming n-grams. Alternatively, such spelling differences can be accounted for when attempting to match a query.

In another optional embodiment, the n-grams (or other sub-queries) formed from a parent query can be limited to n-grams or sub-queries that have less than a threshold number of query terms. For example, the n-grams constructed based on a parent query can be limited to n-grams having 3 query terms or less. In such an example, even though a parent query having 5 query terms could potentially have sub-queries containing 4 query terms, the 4 query term n-grams can be ignored as being greater than the threshold value of 3. In an embodiment, the sub-queries formed from a parent query can be limited to 2 query terms or less, or 3 query terms or less, or 4 query terms or less, or 5 query terms or less, or any other convenient threshold number.

Because sub-queries are smaller than the corresponding parent query, it may be possible to construct a given sub-query from more than one parent query. For example, the 2-element query “chocolate cake” is a sub-query of both the 6-element query “how to make a chocolate cake” and the 3-element query “chocolate cake ingredients”. The parent count for a sub-query is defined as the number of parent queries that can be used to form the sub-query. In some embodiments, the parent count can be restricted to only include parent queries that have an appropriate query length. For example, the parent count can be based on parent queries that have a query length of from 4 to about 60 query elements.

### Query Logfile

A query is typically submitted to a search engine, which matches the search query to documents based on a relevance score. The matching documents can be provided to a user in any convenient manner. One typical format for returning search results is to provide a listing of the ten documents considered by the search engine as having the highest relevance score relative to the query. Links can also be provided to view lists of lower relevance score documents, along with suggestions for related queries. The search engine can determine the relevance score of a document relative to a query by any convenient method. The number of documents returned on the initial results page can also be any convenient number, such as 1, 2, 5, 10, 20, 50, or another number.

When a user submits a search query to a search engine, various types of information can be tracked and recorded in a logfile. One type of information that can be recorded is the query itself. In the logfile, the query submitted by a user can be recorded. Optionally, this can include recording queries that may have spelling errors in a query term. Optionally, the total number of times the query is submitted could also be tracked.

Another type of information that can be tracked is a count of the number of distinct users that have submitted a query. A count of the number of distinct users that have submitted the query can provide an indication of the popularity of a query. As noted above, the total number of times a query is submitted can be tracked. Unfortunately, when a user decides that a query is useful, the same user may submit the query multiple times. This could be due to a desire, for example, to open a second browser to see the query results again while a first browser is still displaying one of the documents identified by the search. One potential improvement on determining the popularity of a query is to track the number of distinct users. The number of distinct users can be determined in a variety of ways. One method for counting distinct users is to increase the distinct user count only once for each identity that submits the search query. Under this option, once a search query has been submitted by a given user identity, the distinct user count will not increase again no matter how many times that user identity submits the query. Another method for counting distinct users is to increase the distinct user count only once within a given time period for each identity. For example, if a user submits a query five times within a 20 minute period, the distinct user count would only be increased once. However, if the same user submits the query 10 days later, the distinct user count would be increased again. Any convenient time period can be used as the time period for allowing another increase in the distinct user count. For example, the time period could be one hour, 24 hours, one week, one month, or any other convenient time period. More generally, any other convenient method for counting the number of distinct users that have submitted a given search query can be used.

Still another type of information that can be recorded is the number of document links accessed by a user from the query results. One option can be to count the total number of documents that a user selects based on a search query. Thus, for each document link that a user selects from the results pages for a query, the count is increased. Another option can be to count the number of documents that a user selects that are considered as “high relevance” documents. One convenient proxy for considering a document as “high relevance” is whether a document is on the first page of results displayed in response to the search query. Alternatively, a high relevance score document can correspond to a threshold number of documents having the highest relevance score relative to the query, such as the top 1, 2, 5, 10, 20, 50, or another convenient threshold number.

In an embodiment, the definition for a high relevance score document can be selected to assist in determining whether the documents that match a query are of interest to a user. For example, a user could submit a query where the high score documents are not of interest to the user. Instead, the user views only documents that are displayed off of the first page and/or have relevance scores below the high relevance score cutoff. In this situation, although the search query produced documents of interest to the user, these documents of interest were not presented as the high relevance score documents. This tends to indicate that the search query may not be as valuable as some other search queries, as the results desired by the user did not correspond to the high relevance score results. Tracking both the total number of page views and the high relevance score page views can help in identifying such queries that may not be as valuable.

By tracking various quantities over a group of users, such as all users using a particular search engine within a defined geographic area, a query logfile can be formed that provides information about search queries. The query logfile can include a listing of queries along with the number of distinct users for each query, the number of high relevance score page views, and the total number of page views. The query logfile can include other data as well, if desired. The query logfile can represent accumulation of data over the group of users over any convenient period of time, such as one or more days, one or more weeks, one or more months, or one or more years. Optionally, the size of the query logfile can be limited be about 6 months or less, or about 10 months or less, or about 12 months or less, or about 18 months or less, or about 24 months or less. Limiting the size of the query logfile can allow for faster calculation times when processing the query logfile data.

### Considerations for Determining a High Rank Sub-Query

The data in a query logfile can be used to assist in identifying highly ranked sub-queries. Highly ranked sub-queries can be determined by a variety of methods. In some embodiments, the system or method used for identifying highly ranked sub-queries can be based on some or all of the following considerations.

One consideration can be selecting sub-queries that are used frequently. For example, a sub-query that does not appear in the query logfile is a sub-query that has not been submitted by a search user. It is unlikely that such a sub-query would be relevant. More generally, the number of distinct users can provide an indication of the popularity and therefore relevance of a sub-query.

Another consideration can be selecting a sub-query that retains as much as possible of the information contained in the original query. In general, a sub-query with more query elements in common with a parent query may retain more of the original meaning of the parent query. As a result, a query with more query elements and/or a higher percentage of the query elements present in a parent query can be an indication of a more relevant query.

Still another consideration can be selecting a sub-query where a large percentage of the page views are high relevance score documents. As described above, the highest relevance documents returned by a search engine, such as the documents displayed on the first page, can provide an indication of whether a given search query produces results that match the intent of a user. A search query that has a large percentage of high relevance page views relative to the total number of page views can be considered to be an effective search query.

Yet another consideration can be the number of parent queries for a sub-query. One of the goals of generating query suggestions can be to provide a user with alternative ways to search for similar subject matter. If a sub-query has relatively few parent queries, there can be a greater likelihood that the sub-query retains the intended meaning of the original query. By contrast, if a sub-query has an excessive number of parent queries, it is somewhat likely that the sub-query includes terms that are more generic, decreasing the likelihood that the sub-query retains the user's original intent. Thus, a sub-query that has a larger number of parent queries can be considered to be a less effective search query.

### Processing a Query Logfile

A query logfile can be obtained by any convenient method. A query logfile can be generated as described above, or a query logfile can be received from another entity, or a query logfile can be assembled by combining information collected from two or more entities. In various embodiments, after obtaining a query logfile, a method for generating query suggestions can be initiated by identifying one or more sub-queries that are highly ranked. A preliminary step for identifying highly ranked sub-queries can be to generate a list of potential parent queries. In an embodiment, only queries having a number of query elements between a minimum and maximum value can be used as parent queries, such as only queries that have a length of from 4 to about 60 query elements. The queries in the query logfile having an appropriate length can be extracted to form a parent query list or file. The parent query list provides the queries that can be used for generating sub-queries for ranking.

Another optional preliminary step can be to filter the query logfile to exclude one or more queries. Queries can be considered not desirable for a variety of reasons. For example, it may be desirable to exclude any queries related to searches for adult content or violent content. Another option could be to exclude any queries that have a low popularity. Queries with low popularity can represent “noise” in the query data, such as queries that contain a misspelled word. To account for this, queries with number of distinct users and/or total page views below a threshold value could be excluded. In some embodiments, queries with less than about 10 distinct users can be excluded, or less than about 25 distinct users, or less than about 100 distinct users. In other embodiments, queries can be excluded if the query has led to about 10 page views or less, or about 25 page views or less, or about 100 page views or less. Queries can be excluded by any convenient method, such as by creating a second file or list that does not contain the excluded queries, or by marking the excluded queries in the query logfile. Alternatively, filtering of queries in the query logfile can be performed each time a query is considered for processing. Note that the parent query list can be formed after the query log is filtered, before the query log is filtered, or after some filtering has been performed. Optionally, filtering can also be performed on the parent query file or list.

The considerations noted above can be used to determine highly ranked sub-queries in a query logfile. The method can begin by filtering the query logfile to remove undesirable queries. This filtered list of queries can then correspond to the query file or query list. A parent query file or list can then be constructed by extracting all queries having a desired length. The query logfile can also be used to determine a “frequency” for each query. In an embodiment, the frequency for a query can be calculated based on the distinct users for a query and the number of page views, possibly including separate consideration for the total number of page views relative to the number of high relevance page views. In another embodiment, the frequency can be calculated based on an equation having features similar to equation (1):

Freq=(# distinct users)*(# high relevance page views)/[1+(# total page views] (1)

In equation (1), the frequency is proportional to the number of distinct users. The frequency is also proportional to the ratio of high relevance page views versus total page views. Many variations are possible for the above equation format. First, it is noted that “1+# total page views” was used in the equation. The “1” is included to prevent the expression from becoming undefined. Use of a non-zero value in that position is valuable for avoiding computational errors. However, those of skill in the art will recognize that this constant is included for convenience of calculation. In other embodiments, if the processing of the query logfile is handled properly, any query in the logfile that would lead to an undefined value in a frequency calculation can be filtered out prior calculating frequencies. This type of convenience for calculation can be used in other equations shown below to avoid the potential for an undefined value.

Another modification that can be made to equation (1) is to include some of the terms as logarithmic terms. In some instances, a query logfile can represent data accumulated for a number of months or even years. In such instances, many of the values in the query logfile may be large in an absolute sense, such as the number of page views or the number of distinct users. For convenience in handling large values, some or all terms in equation (1) could be incorporated as a log value. For example, the distinct users portion of equation (1) could be expressed instead as “log [1+(distinct users)]”. Any convenient base can be used for the logarithm, such as base 2, base 10, or base 20. It is noted again that a 1 was included as a non-zero value for convenience in avoiding a calculation leading to an undefined value.

The parent query file can also be processed to identify potential sub-queries for consideration. As described above, potential sub-queries can be formed by forming n-grams of a parent query. Alternatively, any other convenient method can be used for forming sub-queries, such as forming all position-independent variations having fewer query elements than the parent query. In some embodiments, the potential sub-queries can be limited to sub-queries having less than a threshold number of query terms.

After forming potential sub-queries, the potential sub-queries can be matched to the queries in the query logfile. In an embodiment, potential sub-queries can be matched only with exact matches in the query logfile. Any potential sub-queries that do not have a matching entry in the query logfile can be discarded. The number of parent queries can also be calculated for each of the matched sub-queries. The calculation of the number of parent queries can occur before, during, or after the matching process. The total number of parent queries for a given sub-query can be referred to as the parent count for that sub-query.

At this point, a number of values can be calculated for each query. First, a weighted frequency can be calculated for each sub-query relative to each corresponding parent query for the sub-query. In an embodiment, a weighted frequency can be calculated as

Weighted Freq=(# elements in sub-query)*freq/(# elements in parent query) (2)

The weighted frequency accounts for the relative number of terms in a sub-query as compared to a parent query. This can be calculated for each parent query that can lead to the sub-query, so a sub-query having more than one parent query can have a plurality of different weighted frequency values, depending on the particular parent query that is being considered. Next, the weighted frequency values can be used to calculate normalized weighted frequency values, by accounting for the number of parents for a sub-query. One method of normalizing can be to use the ratio of the total number of queries in the filtered query file (or the query logfile, if no filtering is performed) versus the number of parent queries that can produce a sub-query, or the parent count. In a search context, this normalized weighted frequency is analogous to a TFIDF (term frequency inverse document frequency) value. One possible format for a normalized weighted frequency is

Normalized Weighted Freq=log [Weighted Freq]*(Size of Query list)/(parent count) (3)

Equation (3) can be used to produce a normalized weighted frequency values for a sub-query. The log can have any convenient base, such as base 2, base 10, or base 20.

For sub-queries with more than one parent query, there can be multiple normalized weighted frequency values. To arrive at a single value for use as a ranking value, the normalized weighted frequency values can be averaged, such as by simply summing the normalized weighted frequency values and dividing by the number of values in the sum. Optionally, this average frequency value could be used as a ranking value. In another embodiment, the average frequency value can be adjusted by multiplying the average frequency by the number of elements in the sub-query. This adjusted frequency value can also be used as the ranking value. For simplicity in the discussion below, the adjusted frequency value will be used as the ranking value. However, other adjustments could be made at this point to further modify the ranking value of each sub-query.

After determining the ranking value for a sub-query, a ranking list can be created that contains all of the sub-queries and the corresponding ranking values. This list of sub-queries and ranking values can be used in order to generate query suggestions. This list can be referred to as a ranking list.

### Generating Query Suggestions

Using the list of sub-queries and ranking values, query suggestions can be generated when a query is received. When a query is received, possible sub-queries can be identified. The possible sub-queries can be identified using one of the methods described above, such as creating n-grams from the query or by creating all of the possible position-independent variations of sub-queries having fewer query elements than the original query. Once the possible sub-queries are identified, the ranking for each possible sub-query is determined from the ranking list. The highest ranked sub-query can be selected, or a highest ranking number of sub-queries can be selected, such as the top three.

The one or more selected sub-queries can be offered directly as query suggestions. Alternatively, the one or more selected sub-queries can be used as the basis for using other methods of generating query suggestions. For example, the one or more selected sub-queries can be used as input for a method where a query is supplemented with additional terms to form a suggested query. Alternatively, the one or more selected sub-queries can be used as input for a query suggestion engine, and one or more queries generated by the query suggestion engine can be provided as query suggestions. Since the selected sub-queries are shorter than the initial query, such conventional methods for generating query suggestions may perform better using the selected sub-query.

### Example 1

### Example Using English Query Terms

In order to demonstrate the operation according to an embodiment of the invention, the following prophetic example is offered. The ranking values provided below are intended to illustrate operation of the invention.

In the following example, two queries will be considered for which a query suggestion could be offered. The first query is “chocolate cake nutrition facts” while the second query is “recipe for baking chocolate cake”. In the following example, an embodiment of the invention is being illustrated where the number of query terms in a sub-query is limited to two query terms.

First, the query “chocolate cake nutrition facts” can be used to demonstrate construction of n-grams as potential sub-queries. For this query, there are four n-grams that contain 1 query element: chocolate; cake; nutrition; and facts. There are six n-grams that contain 2 query elements: chocolate cake; chocolate nutrition; chocolate facts; cake nutrition; cake facts; and nutrition facts. There are four n-grams that contain 3 query elements: chocolate cake nutrition; chocolate cake facts; chocolate nutrition facts; and cake nutrition facts. However, because this embodiment only uses sub-queries with 2 or less query elements, the four n-grams with 3 query elements are not considered further. Because n-grams are being used in this example, the order of words in the query is not being altered in the sub-queries.

After determining the potential n-grams (in this case, 1 query element and 2 query element n-grams), the n-grams can be compared with the ranking list to determine the highest ranked sub-query. Table 1 shows the ranking values for several sub-queries. The ranking values in Table 1 represent ranking values generated according to an embodiment of the invention.

TABLE 1

| Sub-query | Ranking value |
|---|---|
| chocolate cake | 2,847,686 |
| nutrition facts | 2,315,702 |
| chocolate | 1,910,153 |
| nutrition | 1,522,711 |
| cake | 669,997 |
| facts | 486,333 |

For the sub-queries shown in Table 1, the sub-query “chocolate cake” has the highest ranking value. Assuming the other 2-element sub-queries have lower ranking values, “chocolate cake” would be the first sub-query selected as either a query suggestion, or as input for another query suggestion algorithm. In an embodiment where more than one sub-query is selected, “nutrition facts” could be the second selected sub-query, while “chocolate” could be the third selection.

The same process can be applied to the query “recipe for baking chocolate cake”. Table 2 shows possible ranking values for several sub-queries. Note that for the example in Table 2, some of the ranking values represent sample values that are used for illustration purpose only.

TABLE 2

| Sub-query | Ranking value |
|---|---|
| recipe chocolate cake | 3,122,456 |
| chocolate cake | 2,847,686 |
| baking chocolate | 2,222,222 |
| recipe cake | 1,854,321 |
| cake | 669,997 |

In Table 2, the sub-query “recipe chocolate cake” has the highest ranking value. Note that the sub-queries “chocolate cake” and “chocolate” have the same ranking value in both Table 1 and Table 2. In various embodiments, a sub-query has a single ranking value in the ranking list. Once the ranking list is formed, the ranking values are used to select all sub-queries, so the ranking value of a particular sub-query does not change depending on the query submitted by a user.

### Example 2

### Example Using Chinese Query Terms

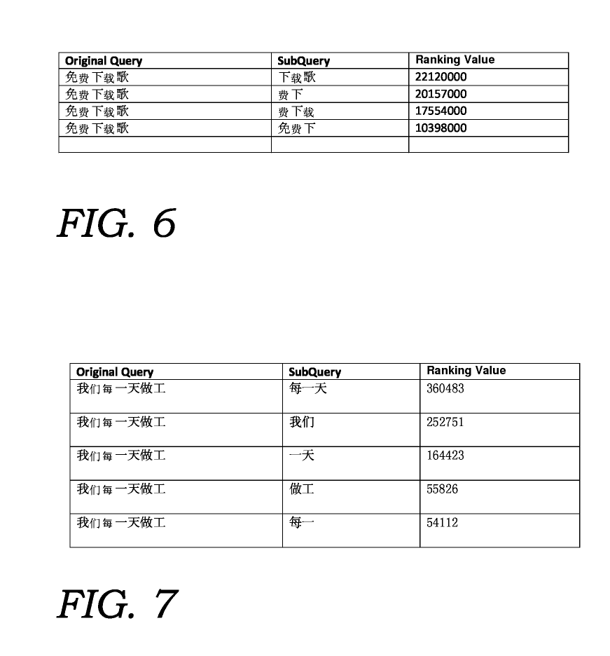

A query logfile was generated by storing information from searches submitted in Chinese characters to a search engine. The query logfile was analyzed according to an embodiment of the invention to produce a ranking table of search queries. FIGS. 6 and 7 shows a table that includes a search query and a listing of rankings from the ranking table for various sub-queries based on the search query. FIGS. 6 and 7 show that embodiments of the invention can be readily applied to a language such as Chinese or Japanese where the query elements are characters, as opposed to a language such as English where the query elements are words composed of letters from an alphabet.

### Additional Embodiments

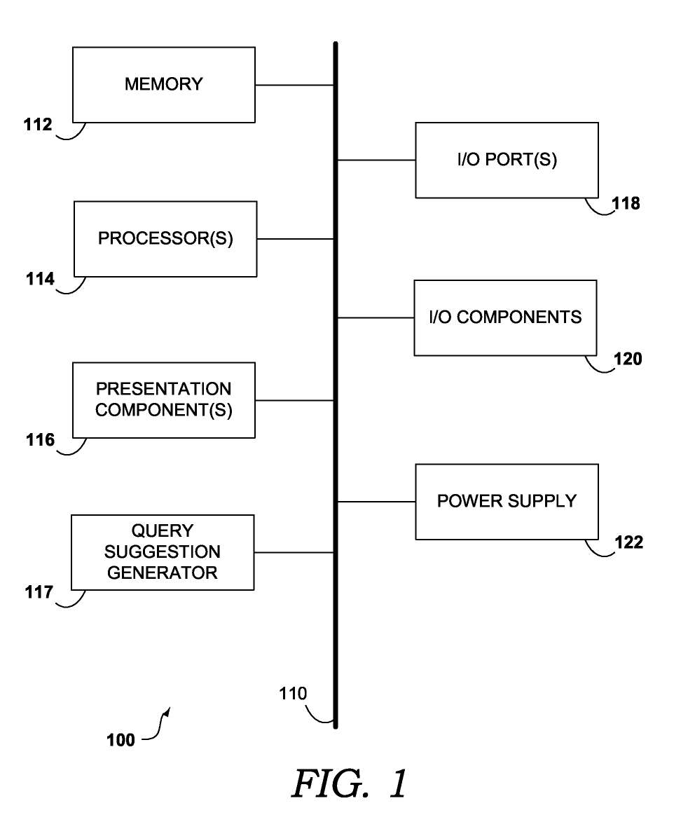

Having briefly described an overview of various embodiments of the invention, an exemplary operating environment suitable for performing the invention is now described. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, and the like. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. FIG. 1 further shows a query suggestion generation component 117 according to an embodiment of the invention. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, carrier wave, or any other medium that can be used to encode desired information and which can be accessed by the computing device 100. In another embodiment, the computer storage media can be a tangible computer storage media. In still another embodiment, the computer storage media can be non-transitory computer storage media.

The memory 112 includes computer-storage media in the form of volatile and/or nonvolatile memory. The memory may be removable, non-removable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

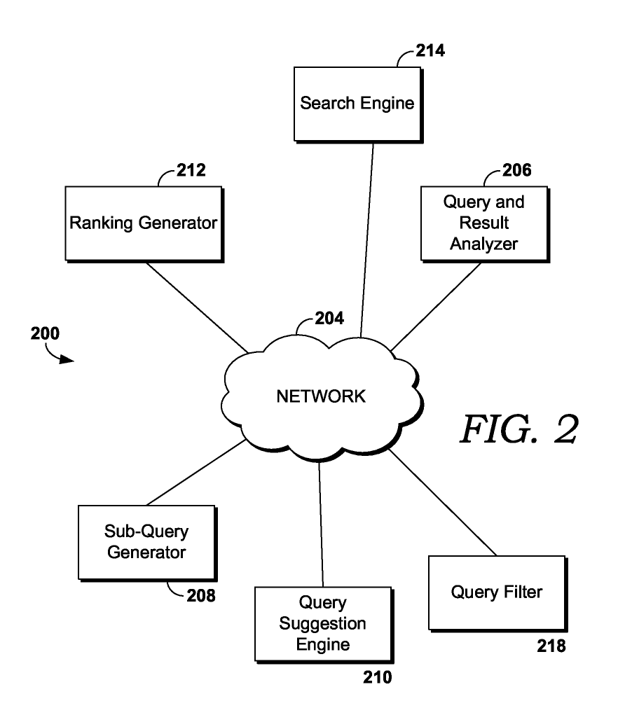

Embodiments of the present invention relate to systems and methods for generating search query suggestions. Turning now to FIG. 2, a block diagram is illustrated, in accordance with an embodiment of the present invention, showing an exemplary computing system 200. It will be understood and appreciated by those of ordinary skill in the art that the computing system 200 shown in FIG. 2 is merely an example of one suitable computing system environment and is not intended to suggest any limitation as to the scope of use or functionality of embodiments of the present invention. Neither should the computing system 200 be interpreted as having any dependency or requirement related to any single component or combination of components illustrated therein. Further, the computing system 200 may be provided as a stand-alone product, as part of a software development environment, or any combination thereof.

The computing system 200 includes a query and result analyzer 206, a query filter 218, a search engine 214, a query suggestion engine 210, a ranking generator 212, and a sub-query generator 208, all in communication with one another via a network 204 and/or via location on a common device. One or more of these elements can be optional depending on the embodiment. While query and result analyzer 206, query filter 218, search engine 214, query suggestion engine 210, ranking generator 212, and sub-query generator 208 are shown as separate elements in FIG. 2, one or more of these elements can be combined in some embodiments. The network may include, without limitation, one or more local area networks (LANs) and/or wide area networks (WANs). Such networking environments are commonplace in offices, enterprise-wide computer networks, intranets and the Internet. Accordingly, the network 204 is not further described herein.

Search engine 214 can be any suitable search engine for receiving a search query and generating a list of matching documents to return as results. Optionally, query and result analyzer 206 can be part of search engine 214. Query and result analyzer 206 can analyze various aspects of the interaction between a user and a search engine. This analysis can be stored in a query logfile. Query and result analyzer 206 can track queries received by search engine 214; track distinct users that have submitted a query; track documents provided in response to a query that are viewed by a user; and track high relevance documents provided in response to a query that are viewed by a user.

Query filter 218 can optionally be part of query and result analyzer 206 and/or search engine 214. Query filter 218 can exclude queries from consideration based on the nature of the query, such as adult or violent content. Query filter 218 can also exclude queries based on the popularity or frequency of the query.

Sub-query generator 208 can generate sub-queries corresponding to a given parent query. Sub-query generator 208 can also determine a number of query terms within a query and/or determine a number of parent queries for a query.

Ranking generator 212 can generate and provide a ranking list for sub-queries. Ranking generator can automatically calculate rankings based on information from a query logfile, without further human intervention. Optionally, query and result analyzer 206 and/or sub-query generator 208 can be part of ranking generator 212.

Query suggestion engine 210 can provide query suggestions based on an input query. Using a sub-query selected based on a ranking from ranking generator 212, query suggestion engine 210 can generate a suggested query by any convenient method, such as adding additional terms or adding and/or replacing terms based on similarity to existing query terms. In some embodiments, query suggestion engine 210 can be a conventional query suggestion engine that can offer improved results based on use of the selected sub-queries instead of a query submitted to search engine 214.

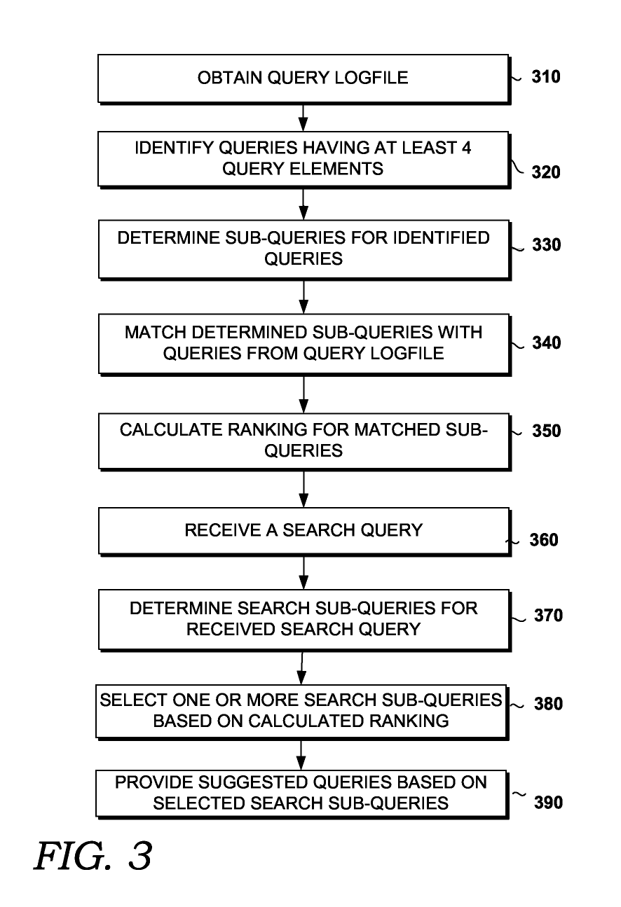

FIG. 3 depicts a flow chart showing a method according to an embodiment of the invention. In the embodiment shown in FIG. 3, a query logfile is obtained 310. Queries, such as queries in the query logfile, having at least 4 query elements are identified 320. Sub-queries are determined 330 for the identified sub-queries. The determined sub-queries are matched 340 with queries from the query logfile. A ranking is calculated 350 for the matched sub-queries. A search query is then received 360. Search sub-queries are determined 370 for the received search query. One or more search sub-queries are selected 380 based on the corresponding ranking that was calculated for the search sub-queries. Suggested queries are then provided 390 based on the selected search sub-queries.

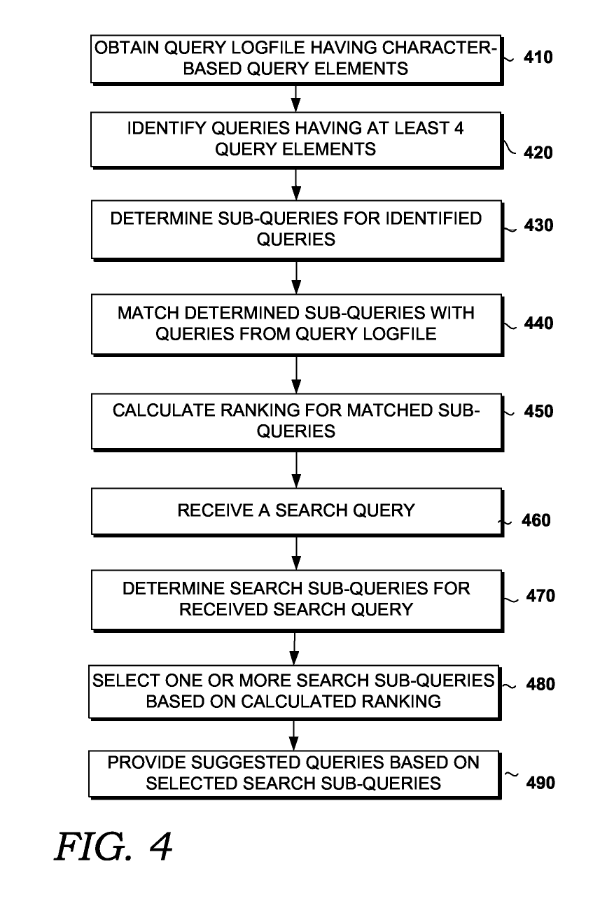

FIG. 4 depicts a flow chart showing a method according to another embodiment of the invention. In the embodiment shown in FIG. 4, a query logfile is obtained 410. The query logfile includes queries that have character-based query elements. Queries, such as queries in the query logfile, having at least 4 query elements are identified 420. Sub-queries are determined 430 for the identified sub-queries. The determined sub-queries are matched 440 with queries from the query logfile. A ranking is calculated 450 for the matched sub-queries. A search query is then received 460. Search sub-queries are determined 470 for the received search query. One or more search sub-queries are selected 480 based on the corresponding ranking that was calculated for the search sub-queries. Suggested queries are then provided 490 based on the selected search sub-queries.

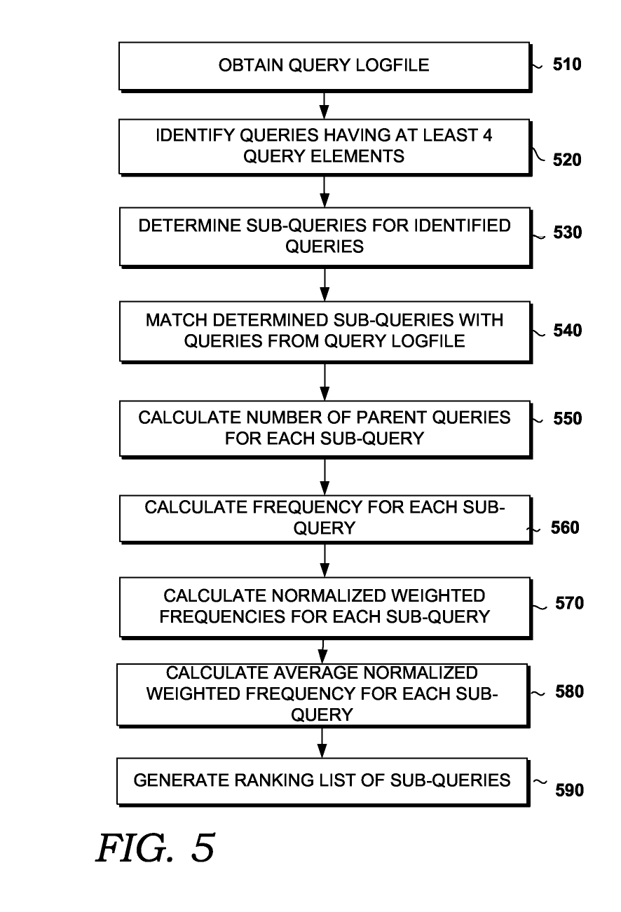

FIG. 5 depicts a flow chart showing a method according to yet another embodiment of the invention. In the embodiment shown in FIG. 5, a query logfile is obtained 510. Queries, such as queries in the query logfile, having at least 4 query elements are identified 520. Sub-queries are determined 530 for the identified sub-queries. The determined sub-queries are matched 540 with queries from the query logfile. A ranking is calculated for the matched sub-queries. Calculation of the ranking includes calculating 550 a number of parent queries for each sub-query. A frequency is calculated 560 for each sub-query. Normalized weighted frequencies are then calculated 570 for each sub-query. Next, an average normalized weighted frequency is calculated 580 for each sub-query. A ranking list is generated 590 based on the average normalized weighted frequency values for the sub-queries.

In another embodiment, a method can be provided for generating query suggestions. Optionally, the method can be provided in the form of one or more computer readable media containing computer executable instructions that, when executed, provide a method for generating query suggestions. The method includes obtaining a query logfile. Optionally, the queries in the query logfile can be queries that have query elements corresponding to a character-based written language, such as Chinese, Japanese, or Korean. Queries contained in the query logfile that have at least 4 query elements can be identified. Sub-queries can be determined for each identified query. The determined sub-queries can be matched to queries in the query logfile. A ranking can be calculated for each matched sub-query, the ranking being based on a number of distinct users, page view data, a number of query elements in the sub-query, and a number of parent queries for the sub-query. A search query can then be received. Search sub-queries can be determined for the received search query, where at least one of the search sub-queries corresponding to a matched sub-query having a calculated ranking. One or more search sub-queries can be selected based on the corresponding calculated ranking of the selected one or more search sub-queries. One or more suggested queries can then be provided based on the selected one or more search sub-queries.

In still another embodiment, a method can be provided for generating query suggestions. Optionally, the method can be provided in the form of one or more computer readable media containing computer executable instructions that, when executed, provide a method for generating query suggestions. The method includes obtaining a query logfile. Optionally, the queries in the query logfile can be queries that have query elements corresponding to a character-based written language, such as Chinese, Japanese, or Korean. Queries contained in the query logfile that have at least 4 query elements can be identified. Sub-queries can be determined for each identified query. The determined sub-queries can be matched to queries in the query logfile. A ranking can be calculated for each matched sub-query. The calculation can include calculating a number of parent queries for each sub-query. A frequency can be calculated for each sub-query based on a number of distinct users and page view information. One or more normalized weighted frequency values can be calculated for each sub-query based on the number of query elements in the sub-query; the number of query elements in a parent query; a number of queries in the query logfile; and a number of parent queries for the sub-query. The number of normalized weighted frequency values calculated for a sub-query can correspond to the number of parent queries for the sub-query. An average normalized weighted frequency value for a sub-query can then be calculated based on the one or more normalized weighted frequency values for the sub-query and the number of parent queries for the sub-query. A ranking list of sub-queries can be generated based on the average normalized weighted frequency values for the sub-queries

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

What is claimed is:

1. One or more computer readable media containing computer executable instructions that, when executed, provide a method for generating query suggestions, comprising:
obtaining a query logfile;
identifying queries contained in the query logfile that have at least 4 query elements;
determining sub-queries for each identified query;
matching the determined sub-queries to queries in the query logfile;
calculating a ranking for each matched sub-query, the ranking being based on a number of distinct users, page view data, a number of query elements in the sub-query, and a number of parent queries for the sub-query;
receiving a search query;
determining search sub-queries for the received search query, at least one of the search sub-queries corresponding to a matched sub-query having a calculated ranking;
selecting one or more search sub-queries based on the corresponding calculated ranking of the selected one or more search sub-queries; and
providing one or more suggested queries based on the selected one or more search sub-queries.

2. The one or more computer readable media of claim 1, wherein determining sub-queries for each identified query comprises determining n-grams having for each identified query.

3. The one or more computer readable media of claim 1, wherein determining sub-queries for each identified query comprises determining position independent sub-queries for each identified query, each position independent sub-query having fewer query elements than the corresponding identified query.

4. The one or more computer readable media of claim 1, wherein said identifying queries contained in the query logfile, said determining sub-queries for each identified query, said matching the determined sub-queries, and said calculating a ranking for each matched sub-query are performed automatically.

5. The one or more computer readable media of claim 1, further comprising filtering the query logfile to exclude one or more queries, wherein identifying queries contained in the query logfile comprises identifying queries based on the filtered queries.

6. The one or more computer readable media of claim 1, wherein determining sub-queries for each identified query comprises determining sub-queries that have a threshold number of query terms or less.

7. The one or more computer readable media of claim 1, wherein providing one or more suggested queries based on the selected one or more search sub-queries comprises using the selected one or more search sub-queries as input for a query suggestion engine and providing at least one query generated by the query suggestion engine.

8. The one or more computer readable media of claim 1, wherein the identified queries contain from 4 to about 60 query elements.

9. A method for generating query suggestions for queries in a character-based written language, comprising:
obtaining a query logfile containing queries having query elements corresponding to characters in a character-based written language;
identifying queries contained in the query logfile that have at least 4 query elements;
determining sub-queries for each identified query;
matching the determined sub-queries to queries in the query logfile;
calculating a ranking for each matched sub-query, the ranking being based on a number of distinct users, page view data, a number of query elements in the sub-query, and a number of parent queries for the sub-query;
receiving a search query;
determining search sub-queries for the received search query, at least one of the search sub-queries corresponding to a matched sub-query having a calculated ranking;
selecting one or more search sub-queries based on the corresponding calculated ranking of the selected one or more search sub-queries; and
providing one or more suggested queries based on the selected one or more search sub-queries.

10. The method of claim 9, wherein the character-based written language is Chinese, Japanese, or Korean.

11. The method of claim 9, wherein determining sub-queries for each identified query comprises determining n-grams having for each identified query.

12. The method of claim 9, wherein determining sub-queries for each identified query comprises determining position independent sub-queries for each identified query, each position independent sub-query having fewer query elements than the corresponding identified query.

13. The method of claim 9, wherein the identified queries contain from 4 to about 60 query elements.

14. The method of claim 9, wherein calculating a ranking for each matched sub-query comprises:
calculating a number of parent queries for each sub-query;
calculating a frequency for each sub-query based on a number of distinct users and page view information;
calculating one or more normalized weighted frequency values for each sub-query based on the number of query elements in the sub-query, the number of query elements in a parent query, a number of queries in the query logfile, and a number of parent queries for the sub-query, wherein a number of normalized weighted frequency values calculated for a sub-query corresponds to the number of parent queries for the sub-query; and
calculating an average normalized weighted frequency value for a sub-query based on the one or more normalized weighted frequency values for the sub-query and the number of parent queries for the sub-query.

15. One or more computer readable media containing computer executable instructions that, when executed, provide a method for automatically generating a sub-query ranking list, comprising:
obtaining a query logfile;
identifying queries contained in the query logfile that have at least 4 query elements;
determining sub-queries for each identified query;
matching the determined sub-queries to queries in the query logfile;
calculating a ranking for each matched sub-query, the calculation comprising:
calculating a number of parent queries for each sub-query;
calculating a frequency for each sub-query based on a number of distinct users and page view information;
calculating one or more normalized weighted frequency values for each sub-query based on the number of query elements in the sub-query, the number of query elements in a parent query, a number of queries in the query logfile, and a number of parent queries for the sub-query, wherein a number of normalized weighted frequency values calculated for a sub-query corresponds to the number of parent queries for the sub-query; and
calculating an average normalized weighted frequency value for a sub-query based on the one or more normalized weighted frequency values for the sub-query and the number of parent queries for the sub-query;
and
generating a ranking list of sub-queries based on the average normalized weighted frequency values for the sub-queries.

16. The one or more computer readable media of claim 15, wherein the average normalized weighted frequency value is further based on the number of query terms in the sub-query.

17. The one or more computer readable media of claim 15, wherein the method further comprises providing the generated ranking list to a query suggestion engine.

18. The one or more computer readable media of claim 15, wherein the method further comprises:
receiving a search query;
determining search sub-queries for the received search query, at least one of the search sub-queries corresponding to a sub-query in the ranking list;
selecting one or more search sub-queries based on the corresponding calculated ranking of the selected one or more search sub-queries; and
providing one or more suggested queries based on the selected one or more search sub-queries.

19. The one or more computer readable media of claim 15, wherein a query element corresponds to a character of a character-based written language.

20. The one or more computer readable media of claim 15, further comprising filtering the query logfile to exclude one or more queries, wherein identifying queries contained in the query logfile comprises identifying queries based on the filtered queries.
